(19) United States
(12) Patent Application Publication
(10) Pub. No.: US 2006/0187661 A1
(43) Pub. Date: Aug. 24, 2006

(54) Luminaire

(76) Inventor: Petrus Adrianus Josephus Holten, Winterswijk (NL)

Correspondence Address: PHILIPS INTELLECTUAL PROPERTY & STANDARDS, P.O. BOX 3001, BRIARCLIFF MANOR, NY, 10510, US

(21) Appl. No.: 10/549,233

(22) PCT Filed: Mar. 15, 2004
(86) PCT No.: PCT/IB04/50248

§ 371 Date: Sep. 12, 2005

(30) Foreign Application Priority Data
Mar. 17, 2003 (EP) 03100671.1

(51) Int. Cl. F21V 7/00

(52) U.S. Cl. 362/298; 362/299; 362/328; 362/329

(57) ABSTRACT

The invention relates to a luminaire for indirect lighting. The luminaire comprises a main reflector (5), a counter-reflector (13) with a light emission window (15) in a plane T, the counter-reflector (13) and reflector (5) being oppositely arranged. The main reflector (5), having a reflecting surface built up from a plurality of facets (7) having a curvature (11) in cross-section, is characterized in that the curvature (11) of each respective facet n is such that light coming from a light emission window (15) and hitting said facet n is reflected through an angle of reflection Phi n<=aplpha n−bèta, in which: bèta is a smallest angle of reflection with plane T at which glare is just counteracted, and alpha n is a greatest angle of reflection with plane T at which reflected light just clears the counter-reflector (13).

The invention relates to a luminaire comprising:

an elongate reflector extending along an axis and comprising a plurality of elongate facets extending along one another and along said axis, each with a reflecting surface, which facets have a curvature in cross-section;

an elongate concave counter-reflector extending along said axis such that the reflecting surfaces of the facets and a light emission window of the counter-reflector, which is situated in a plane T, mutually face one another;

contact means positioned between the reflector and the counter-reflector for accommodating at least one electric lamp.

The invention further relates to an assembly of an electric lamp and a luminaire.

Such a luminaire is known from U.S. Pat. No. 1,900,551. The known luminaire is designed for use as an indirect light source for general lighting purposes. The facets of the reflector are straight or convexly curved towards the counter-reflector, as viewed in cross-section. The known luminaire provided with facets that are straight in cross-section has the disadvantage that the facets reflect the light originating from the electric lamp with an undesirable high brightness, which increases the risk of glare and renders a control of contrast differences with the surroundings more difficult. A light beam of such an undesirable high brightness, moreover, is often felt to be unpleasant by an observer. If the known luminaire is provided with facets that are convex in cross-section, the curvature of the facets is such and the facets are positioned and oriented with respect to the electric lamp such that light originating from the light source and incident on the facets is partly reflected back by the facets into the luminaire, especially onto the electric lamp and the counter-reflector. It is a disadvantage of the known luminaire, when having facets that show a curvature in cross-section, that a light beam is obtained from the luminaire in a comparatively unfavorable and inefficient manner.

It is an object of the invention to counteract the disadvantages of the luminaire mentioned in the opening paragraph. To achieve this object, the luminaire of the kind described in the opening paragraph is characterized in that the curvature of a facet n is such that during operation of the electric lamp light coming from the light emission window and incident on each respective facet n is reflected as a beam having a beam angle Φₙ, a maximum angle of reflection at which light of said beam is reflected being at most equal to αₙ, wherein αₙ is an angle of reflection with respect to the plane T at which the light is reflected such that it just shears along the counter-reflector.

The luminaire according to the invention may then comprise facets which have a concave or convex curvature towards the counter-reflector in cross-section. Alternatively, the luminaire according to the invention may comprise convexly shaped and concavely shaped facets. The curvature may follow, for example, an arc of a circle, parabola, hyperbol, or ellipse, or it may alternatively be achieved in that the facets are composed of sub-facets. The reflector may comprise central facets which are present directly opposite the light emission window, which facets are straight in cross-section and form, for example, a (sharp) point such that an at least substantially equal distribution of light quantities over the two sides of the luminaire is achieved. These central facets may be at least substantially entirely screened off against direct observation by the counter-reflector, so that the observer is protected against possible glare caused by light reflected by these straight facets.

Giving the facets the curvature as defined in the characterizing portion of claim 1 achieves that each respective facet n supplies a light beam with a beam angle Φₙ. When an observer views the luminaire according to the invention, in which Φₙ is at least substantially equal to αₙ for a facet n, it was found that this observer has a perception as if an integral, somewhat dimmed light beam is provided by this facet n of the luminaire. The individual facets of the luminaire can be distinguished by the observer owing to transition regions of contrasting brightness between the facets. The light reflected as a beam by each respective facet n has a maximum beam angle of Φₙ=αₙ. The value of the angle αₙ is determined from a construction of the paths of light rays in the plane of cross-section of the luminaire. Dazzling of an observer was found to be counteracted with the luminaire according to the invention. It is achieved at the same time that light originating from the electric lamp during operation is not reflected back into the luminaire by the facets owing to the shape of the facets as defined in the characterizing portion of claim 1. A light beam can thus be obtained from the luminaire in a comparatively favorable and efficient manner.

In a favorable embodiment, the luminaire according to the invention is characterized in that a minimum angle of reflection with plane T at which light of the beam is reflected is at least equal to β, wherein 0≦β<αₙ, with preferably β=30°. The light reflected as a beam by each respective facet n has a maximum beam angle of Φₙ=αₙ−β. An agreed standard requirement in lighting technology is that the angle β in a horizontal position of plane T is at least 30° in the case of luminaires serving for illumination from the ceilings of spaces containing office furniture with picture screens, so as to prevent mirroring and glare on said screens. For β>0, all light is reflected in the direction of the office furniture. β may have values other than 30°, for example 20°, for the illumination of spaces having other applications.

The beam angle Φₙ in the luminaire according to the invention may be adjusted within the given limits αₙ and β by means of small variations in the curvature of the facet n. It is favorable then when the curvature of facets lying closest to the contact means has a radius Rₙ which is greater than the radius of curvature of facets situated farther away from the contact means. As a result, the facets may have at least substantially the same dimension in cross-section, while it is achieved at the same time that each respective facet n supplies a light beam with more or less the same beam angle Φₙ, given said dimension in cross-section of the facets. It was found in experiments for luminaires thus shaped that an observer experiences an optical effect as if light of the same brightness is radiated by all facets. It was also found that said optical effect is especially functional if it is true for the radius Rₙ of each respective facet n, which facet n is irradiated with an angle of aperture δₙ from the light emission window, that 0.5δₙ≦Rₙ≦2δₙ, wherein Rₙ is the radius of curvature of a facet n expressed in mm and δₙ is expressed in degrees.

A luminaire according to the invention with which the brightness of the generated light can be adjusted by an additional method is characterized in that the curvature of each facet is bounded by an end portion in the form of a respective fold extending along the axis, such that in cross-section said fold shows a bend through at least an angle γ=30° and a radius of curvature R_{fil} lying in a range of 0.1 mm≦R_{fil}≦3 mm. The end portion thus formed acts as a strongly diverging, luminous linear element with which the brightness of the transition region between two mutually adjoining facets can be adjusted. Given values of the radius of curvature R_{fil} below the minimum value of the above range, the transition region will be observed to have an insufficiently stronger brightness, or no stronger brightness at all. Given values of R_{fil} above the maximum value of the above range, an observer will perceive the brightness of the transition region as being too high. The folded end portion of a respective facet located closest to plane T will always receive light as a rule during operation of the electric lamp and will accordingly always be functional as a bright linear element. The folded end portion of a respective facet lying farthest away from plane T is usually screened off against direct reception of light by an adjacent facet and will accordingly as a rule not be functional as a bright linear element. The latter end portion, therefore, is usually not optimized for its function as a luminous linear element, but rather optimized with regard to its mechanical properties, facilitating the manufacture of reflector material from a flat plate.

In a favorable embodiment, the luminaire according to the invention is characterized in that the reflector has a width/height ratio of at least 4:1, while the reflector may have an overall convex or concave curved shape in cross-section. Said width/height ratio gives the luminaire a small constructional or incorporation depth, which renders it suitable for use in comparatively shallow false ceilings and/or comparatively low spaces. Particularly preferred is a luminaire according to the invention that has a reflector whose facets lie substantially in a plane Q, which plane Q extends parallel to the plane T, such that a substantially minimum constructional or incorporation depth is achieved.

In an alternative embodiment, the luminaire according to the invention is characterized in that the reflector and/or the counter-reflector are provided with light-transmitting means, for example openings (holes) or optical waveguide elements (optical fibers), which are preferably evenly distributed over the surface of the reflector and/or counter-reflector. If the light-transmitting means are provided in the reflector, it has become possible for an observer to perceive a subtle indirect lighting coming from a carrier, for example a ceiling, to which the luminaire is fastened. If the light-transmitting means are provided on the counter-reflector, a difference in brightness between the reflector and the counter-reflector as perceived by an observer will be counteracted, so that it is achieved that an observer experiences the optical effect that light of the same brightness is given off by the entire luminaire.

A possible embodiment of the luminaire according to the invention is characterized in that mutually adjacent facets are interconnected by connecting surfaces, such that the connecting surfaces located closer to the contact means enclose a greater angle μ with the plane T than the connecting surfaces located farther away from the contact means and are oriented such that they reflect at least substantially no light originating from the electric lamp during operation of this lamp. This counteracts the risk that the connecting surfaces of the luminaire could give off light of a comparatively high brightness, which may be experienced as unpleasant by an observer. Alternatively, the connecting surfaces may be provided with openings designed for the removal of hot air coming from the electric lamp Light losses through such openings are thus counteracted.

The object of the invention may alternatively be achieved by means of an assembly of a luminaire in one of the embodiments as described above and an electric lamp, characterized in that the counter-reflector is an integral part of the electric lamp, for example a coating, for example of aluminum oxide. The coating leaves a portion of the circumference of the electric lamp permeable to light, which permeable portion acts as the light emission window. It is achieved with such an assembly that the separate counter-reflector can be dispensed with, whereby a very small incorporation or constructional depth of the assembly is realized. The incorporation or mounting depth is a minimum if the facets in the luminaire according to the invention lie at least substantially in a plane Q, which plane Q extends parallel to the plane T.

Embodiments of the luminaire according to the invention are diagrammatically shown in the drawing, in which

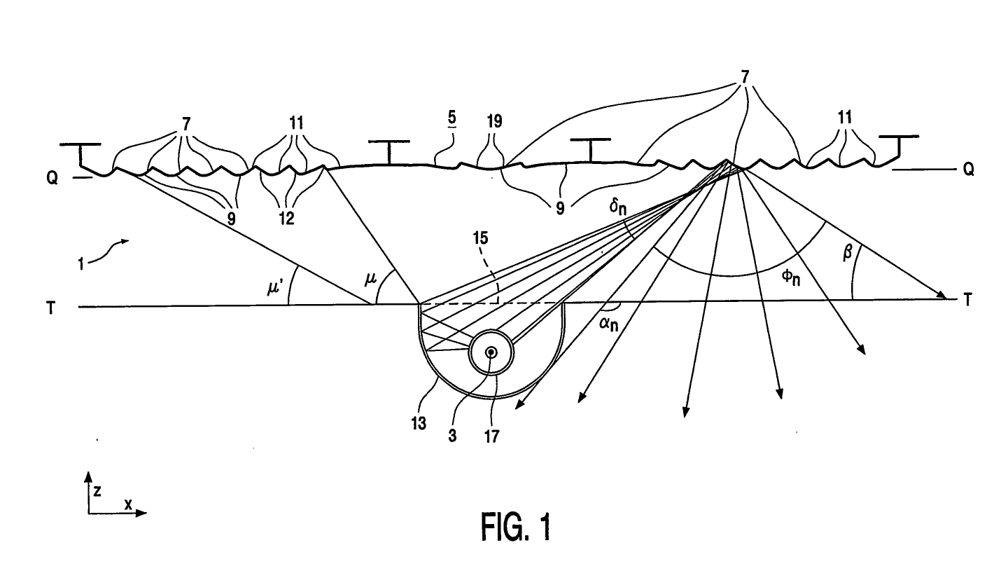

FIG. 1 is a cross-sectional view of an embodiment of a luminaire according to the invention, and

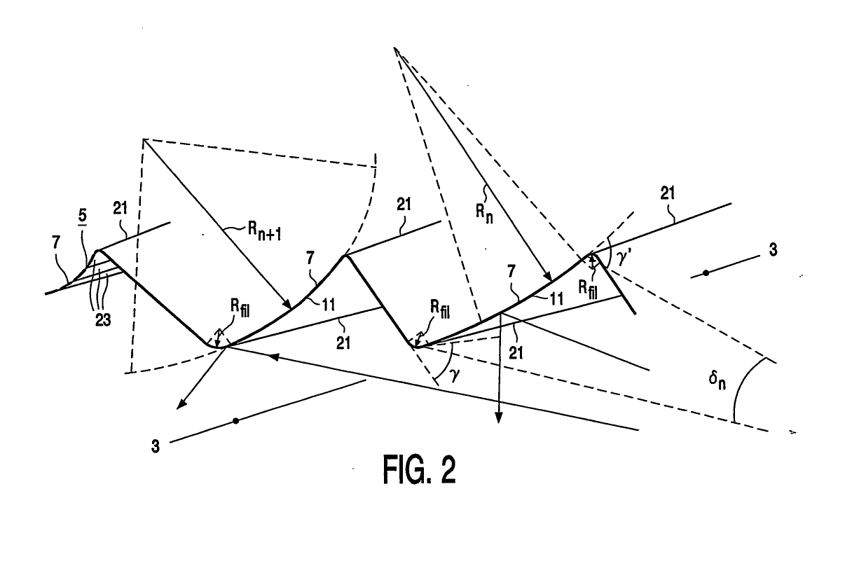

FIG. 2 is a perspective cross-sectional view of a detail of the luminaire of FIG. 1.

FIG. 1 shows a luminaire 1 comprising an elongate reflector 5 extending along an axis 3 and comprising a plurality of elongate facets 7 extending along one another and along the axis, each with a reflecting surface 9, which facets have a curvature 11 in cross-section. Mutually adjoining facets are interconnected by connecting surfaces 12. Connecting surfaces located closer to the contact means enclose a greater angle μ with a plane T than the angle μ′ enclosed between the plane T and connecting surfaces located farther away from the contact means. The connecting surfaces are oriented such that they reflect at least substantially no light originating from the electric lamp during operation of this lamp. The luminaire also comprises an elongate concave counter-reflector 13 extending along the axis, such that the reflecting surfaces 9 of the facets 7 and a light emission window 15 of the counter-reflector 13, which window lies in a plane T, face one another. Between the reflector and the counter-reflector, the luminaire is provided with contact means (not shown) in which an electric lamp 17 is held. The lamp may be a discharge lamp, for example a tubular low-pressure mercury vapor gas discharge lamp, or an incandescent lamp, for example a halogen incandescent lamp. The reflector and counter-reflector may be manufactured, for example, from synthetic resin, for example polythene, or from bent metal plating, for example aluminum. The reflecting surface may be a layer provided on the (counter-)reflector, for example by means of vapor deposition, for example of anodized aluminum, or may be a mirroring coating foil. Each facet n is irradiated from the light emission window at an angle of aperture δₙ for the relevant facet n. The curvature of a large majority of the facets 7 is such that light incident on the facets 7 from the light emission window 15 is reflected at a beam angle Φₙ, such that Φₙ=αₙ−β. β is the minimum angle of reflection with plane T at which light of the beam is reflected and is chosen such that glare is just prevented; β≈40° in FIG. 1. αₙ is a greatest angle of reflection with the plane T at which the light is reflected so as to shear just along the counter-reflector. αₙ and β are also the maximum and minimum reflection angles, respectively, at which light of the beam is reflected. A number of central facets 19 from among the facets 7 are straight in cross-section. The facets of the reflector shown in FIG. 1 lie substantially in a plane Q, which plane Q extends parallel to the plane T. The reflector 5 has a width/height ratio of at least 4:1, which ratio is approximately 20:1 in FIG. 1. The luminaire has a comparatively small mounting or incorporation depth as a result of this ratio and is thus suitable for use in comparatively shallow false ceilings and/or comparatively low spaces.

FIG. 2 shows a detail of a number of facets 7 of the reflector 5 of the luminaire 1 of FIG. 1, in which it is apparent that the facets are bounded on either side by respective end portions 21 in the form of respective folds extending along the axis 3, such that in cross-section a fold has a curvature through at least an angle γ=30°, for example in FIG. 2 γ=60° and γ′=70°, and has a radius of curvature R_{fil} in a range of 0.1 mm≦R_{fil}≦3 mm, with in FIG. 2 R_{fil}≈2.5 mm. It is also shown that the curvature 11 of facets located closer to the contact means has a radius Rₙ which is greater than the radius Rₙ₊₁ of the curvature 11 of facets located farther away from the contact means, for example 15 and 20 mm in FIG. 2. The angle of aperture δₙ at which the facet with radius Rₙ is irradiated from the light emission window is approximately 15°. It is true for this facet, but also for most other facets, that 0.5δₙ≦Rₙ≦2δₙ, wherein Rₙ is the radius of the curvature of a facet n expressed in mm and δₙ is expressed in degrees. By way of illustration, FIG. 2 shows a facet whose curvature is obtained by means of sub-facets 23. The other facets shown in FIG. 2 have a curvature in accordance with an arc of a circle.

1. A luminaire comprising:
an elongate reflector extending along an axis and comprising a plurality of elongate facets extending along one another and along said axis, each with a reflecting surface, which facets have a curvature in cross-section;
an elongate concave counter-reflector extending along said axis such that the reflecting surfaces of the facets and a light emission window of the counter-reflector, which window is situated in a plane T, mutually face one another;
contact means positioned between the reflector and the counter-reflector for accommodating at least one electric lamp, characterized in that the curvature of a facet n is such that during operation of the electric lamp light coming from the light emission window and incident on each respective facet n is reflected as a beam having a beam angle Φₙ, a maximum angle of reflection at which light of said beam is reflected being at most equal to αₙ, wherein αₙ is an angle of reflection with respect to the plane T at which the light is reflected such that it shears along the counter-reflector.

2. A luminaire as claimed in claim 1, characterized in that a minimum angle of reflection with plane T at which light of the beam is reflected is at least equal to β, wherein 0≦β<αₙ, with preferably β=30°.

3. A luminaire as claimed in claim 1, characterized in that the curvature of facets lying closest to the contact means has a radius Rₙ which is greater than the radius of curvature of facets situated farther away from the contact means.

4. A luminaire as claimed in claim 1, characterized in that it is true for the radius Rₙ of each respective facet n, which facet n is irradiated at an angle of aperture δₙ from the light emission window, that 0.5δₙ≦Rₙ≦2δₙ, wherein Rₙ is the radius of curvature of a facet n expressed in mm and δₙ is expressed in degrees.

5. A luminaire as claimed in claim 1, characterized in that the curvature of each facet is bounded by an end portions on either side and each end portion having the shape of a respective fold extending along the axis, such that in cross-section said fold shows a bend through at least an angle γ=30° and a radius of curvature R_{fil} lying in a range of 0.1 mm≦R_{fil}≦3 mm.

6. A luminaire as claimed in claim 1, characterized in that the reflector has a width/height ratio of at least 4:1.

7. A luminaire as claimed in claim 1, characterized in that the facets lie substantially in a plane Q, which plane Q extends parallel to the plane T.

8. A luminaire as claimed in claim 1, characterized in that the facets are formed from sub-facets.

9. A luminaire as claimed in claim 1, characterized in that the reflector and/or counter-reflector are/is provided with light-transmitting means.

10. A luminaire as claimed in claim 9, characterized in that the light-transmitting means are openings which are preferably evenly distributed over the surface of the reflector and/or counter-reflector.

11. A luminaire as claimed in claim 1, characterized in that the reflector has central facets located directly opposite the light emission window, which facets are straight in cross-section.

12. A luminaire as claimed in claim 1, characterized in that mutually adjacent facets are interconnected by connecting surfaces, such that the connecting surfaces located closer to the contact means enclose a greater angle μ with the plane T than the connecting surfaces located farther away from the contact means and are oriented such that they reflect at least substantially no light originating from the electric lamp during operation of this lamp.

13. An assembly of a luminaire as claimed in claim 1 and an electric lamp, characterized in that the counter-reflector is an integral part of the electric lamp.
